(19) United States
(12) Patent Application Publication
(10) Pub. No.: US 2025/0145273 A1
(43) Pub. Date: May 8, 2025

(54) DOUBLE Y-SHAPED SPAR MADE OF COMPOSITE MATERIAL

(71) Applicant: AIRBUS OPERATIONS, S.L.U., GETAFE (Madrid) (ES)

(72) Inventors: Alvaro JARA RODELGO, GETAFE (Madrid) (ES); Miguel GONZALEZ ANTOHI, GETAFE (Madrid) (ES); Mikel DE LA PUERTA VALLEJO, GETAFE (Madrid) (ES)

(21) Appl. No.: 18/940,592

(22) Filed: Nov. 7, 2024

(30) Foreign Application Priority Data
Nov. 7, 2023 (EP) 23383135.3

(51) Int. Cl. B64C 3/18; B29C 70/46; B29L 31/30

(52) U.S. Cl. CPC B64C 3/185; B29C 70/462; B29C 2793/009; B29L 2031/3085

(57) ABSTRACT

A double Y-shaped cross-section spar (100) for an aircraft torsion box including a spar web (110) having an I-shaped cross-section, an upper part connected by the spar web (110), a lower part including lower flanges (130a, 130b) configured to be connectable to a first panel (1010) of the torsion box, a first cross-section opened triangular-shaped structure (120) including first and second lower vertices (120a, 120b) respectively joined to the lower flanges (130a, 130b) and an upper vertex (120c) connected to a first end of the spar web (110) and the upper part comprising upper flanges (130c, 130d) connectable to a second panel (1020) panel of the torsion box, a second cross-section opened triangular-shaped structure (140) including first and second upper vertices (140a, 140b) respectively joined to the upper flanges (130c, 130d) and a lower vertex (140c) connected to a second end of the spar web (110).

### RELATED APPLICATION

This application incorporates by reference and claims priority to European patent application 23383135.3 filed Nov. 7, 2023.

### TECHNICAL FIELD

The invention is in the field of spars made of composite materials, such as spars used in the aerospace industry having a double Y-shape cross-section. Spars may be in an airframe including in torsion boxes of wings.

### BACKGROUND

EP3095691A1 describes a multi-spar torsion box structure including composite material spars arranged to form a multi-cell structure with cells extending in a span-wise direction one after the other in a torsion box. Upper and lower skin covers formed of a composite material are respectively joined to upper and lower surfaces of the multi-cell structure with the spars.

Double T-section spars and omega section spars are used in multi-spar torsion boxes. These spars tend to have a limited momentum of inertia, and may suffer from buckling, post-buckling and have other disadvantageous torsional behaviors.

### SUMMARY

There is a need for spars that are resistant to buckling, post-buckling and other disadvantageous torsional behaviors. Furthermore, there is a need for spars that can in manufacture provide weight savings and cost savings as compared to existing spars and torsion boxes. The invention may be embodied as spars that are resistant to buckling, post-buckling and other disadvantageous torsional behaviors and/or may be made to have relatively low weight and at reduced cost as compared to existing spars.

The invention may be embodied as a double stringer spar that includes an elongated core or web configured to connect the spar to panels of a torsion box such as for a wing, vertical tailplane (VTP) or horizontal tailplane (HTP). The proposed composite material spar can be spaced further apart in a torsion box compared to conventional spars for the same torsion box. Hence, the present invention permits the replacement of two conventional spars of the state of the art by the proposed composite material spar of the invention. Furthermore, the number of spars used in a torsion box can be reduced when substituting conventional spars by the composite material spar according to the present invention to obtain the same mechanical characteristics.

Hence, the present invention may be embodied as a composite material spar (carbon fiber or glass fiber with thermoset or thermoplastic resin) that comprises upper flanges and lower flanges and that can be used in e.g., a torsion box of a wing by joining the upper flanges of the spar to a first (composite) panel of a torsion box of the aircraft and the lower flanges of the spar to a second (composite) panel of the torsion box of the aircraft, wherein the second panel is opposite to the first panel. The proposed spar comprises a structural cross-section that has a shape in double Y. This shape is specified in the present description as a double Y-shape and can correspond to the total or a part of the structural cross-section of the spar.

Furthermore, the use of composite materials provide excellent mechanical and weight properties, as well as the inspections and repairability compared to current spars made of CFRP (carbon fiber reinforced polymer).

The inventive spar may be embodied as a double Y-shaped cross-section spar. The double Y-shaped cross-section spar according to the present invention comprises at least: two cross-section opened triangular-shaped structures connected by a web that provides a double cross-section Y-shape. Furthermore, the double Y-shaped cross-section spar comprises upper and lower flanges connectable to panels of a torsion box of the aircraft. The double Y-shaped or double Y-section cross-section spar made of composite material has various benefits such as better structural efficiency, less wrinkles when manufacturing due to high angles (e.g. above 90 degrees, e.g. between 100 to 165 degrees), no corrosion and better Non-Destructive Testing, NDT process.

The cross-section opened triangular-shaped structures of the double Y-shaped cross-section spar enhances its behavior to torsional loads. Furthermore, the slim part normal to the flange, called web, increases the momentum of inertia and the structural stiffness of the spar. The web or spar web can comprise manholes to allow the maintenance and repair activities or other type of holes, e.g. holes that permit aircraft systems passing through.

Furthermore, the double Y-shaped cross-section spar can have various cross-section shapes and can comprise vertical fins and an intermediate cap having a cross-section in a cross-shape, wherein the intermediate cap comprises upper and lower sections, each section having a T-shape cross-section each comprising a symmetric laminate. The use of composite materials for this purpose enhances the actual spar properties, as well as the inspections and repairability. The advantage of the intermediate cap is the ease of manufacturing the double Y-shaped cross-section spar. Connecting two separated halves of the double Y-shaped cross-section spar at an intermediate point facilitates the manufacturing. Thus, the T-shapes of the two halves are connected to form the upper and lower sections that, once joined to each other, form the intermediate cap. The two part may be joined by various techniques, but the T-shape of the upper and lower sections allow for example riveting, or a larger surface of contact for gluing, co-bounding or co-curing.

The proposed double Y-shaped cross-section spar according to the present invention provides an optimization of the conventional spars and can be used to connect two (composite) panels of a torsion box of the aircraft.

The double Y-shaped cross-section spar may be configured to provide: better torsional and strain structural efficiency; fewer wrinkles during manufacturing spar including where there are large angles, or lower corrosion.

Better NDT process. Currently in L-shape or T-shape spars, since they have curvature angles of 90° and a small curvature radio, their mechanical defects cannot be observed well through a NDT process. Contrarily, with curvature angles above 90° as the ones used in the manufacturing process for obtaining the double Y-shaped according to the present invention, this issue is solved. Less weight and/or One-Shot Assembly: reduced assembly cycle using co-curing.

The double Y-shaped cross-section spar according to the present invention provides an optimization of the “double T”-section and the “omega”-section spars existing in the art. Advantageously, the proposed double Y-shaped cross-section spar increases the momentum of inertia, enhances the buckling and post-buckling behavior, as well as the torsional behavior, and provides the most efficient cross-section shape. Furthermore, the Y-section optimizes the disposition of spars due to the wider effective surface of the feet, which implies weight savings, in particular because since the number of spars required to obtain the same mechanical properties may be lower when the spar according to the present invention is used instead of the spars existing in the state of the art, cost savings and a higher ROI.

Hence, in a first aspect, the invention may be embodied as a double Y-shaped cross-section spar made of composite material for an aircraft, the double Y-shaped cross-section spar that comprises a spar web having a cross-section in a I-shape, a lower part and an upper part connected by the spar web. The lower part comprises lower flanges configured to be connectable to a first panel of a torsion box of the aircraft, a first cross-section opened triangular-shaped structure that comprises first and second lower vertices respectively joined to the lower flanges and an upper vertex connected to a first end of the spar web. The upper part comprises upper flanges configured to be connectable to a second panel opposite the first panel (1010) of the torsion box of the aircraft, a second cross-section opened triangular-shaped structure that comprises first and second upper vertices respectively joined to the upper flanges and a lower vertex connected to a second end of the spar web. The first cross-section opened triangular-shaped structure, the second cross-section opened triangular-shaped structure and the spar web form a cross-section in a double Y-shape.

In one example, the lower flanges and the upper flanges are established in a preferably perpendicular direction to the spar web. The direction of the lower flanges and the upper flanges may not be totally perpendicular when the spars are integrated into a torsion box of the aircraft, wherein the torsion box comprised a first and second panel opposite to the first panel, wherein the first and second panel are established in a curved fashion.

In one example, the spar web further comprises an intermediate cap having a cross-section in a cross-shape, wherein the intermediate cap comprises upper and lower sections, each section having a T-shape cross-section each comprising a symmetric laminate and being connected to each other.

Graphite fiber-reinforced polymer, CFRP's are made of several layers. Each layer is a “cloth,” “ribbon,” or “strip” (like a piece of cloth) of carbon fibers. In this “fabric” the fibers can be disordered, woven or mostly oriented in one direction. In general, those that have a main orientation are used, because in this main direction we know that it has resistance to significant loads. Then, when the layers are stacked, each layer can be oriented as desired to adapt the load resistance of the final piece according to the orientations of each of its layers.

Composite laminates are oriented to achieve desirable properties, such as to avoid buckling and to prevent warping after manufacturing. For example, the laminate may be symmetrical and balanced. The improvement of the laminate properties is related to where the fibers angles are oriented. That is, if the load goes in the direction of 0° according to the double Y-shaped spar reference axis, a greater percentage of laminates will be placed at 0° with respect to the double Y-shaped spar reference axis because that is where the laminates will have the best mechanical properties. The total percentage is divided into laminates at 0°, laminates at 90° and laminates at +/−45°. So, as the different parts of the Y-shaped spar work differently (lower flanges, the spar web and the intermediate cap), each part has to have a greater amount of laminates in the orientation in which it is of interest for the best mechanical response. An example of a symmetrical and balanced composite laminate may be: +45°, −45°, 0°, 90°, 0°, 0°, 90°, 0°, −45°, +45°, which is also written as (+45,−45,0,90,0)S).

In one example, the intermediate cap comprises upper and lower sections, each section having a T-shape cross-section each comprising a symmetric laminate composed by:
a first layer comprising composite laminates that wrap the lower flanges, or upper flanges and the spar web, wherein a 70% of the total composite laminates from the first layer are oriented at a load angle +/−45°, wherein the load angle is the angle of the load with respect to the double Y-shaped spar reference axis;
a second layer comprising composite laminates that can be established on top of the first layer wherein a 70% of the total composite laminates from the first layer are oriented at a load angle 0°; and
a third layer comprising composite laminates that can be established on top of the second one, wherein a 70% of the total composite laminates from the third layer are oriented at a load angle +/−45°.

In one example, the lower flanges and the upper flanges comprise vertical fins established in a parallel direction to the spar web.

The composite material can comprise carbon fiber with thermoset or thermoplastic resin or glass fiber with thermoset or thermoplastic resin.

In some examples, the spar web further comprises manholes.

Another aspect of the present invention refers to the use of the double Y-shaped cross-section spar according to the first aspect of the invention in a torsion box of the aircraft by joining the lower flanges of the double Y-shaped cross-section spar to a first composite panel of a torsion box of the aircraft and joining the upper flanges of the double Y-shaped cross-section spar to a second composite panel of the torsion box of the aircraft.

In one example, joining the lower flanges of the double Y-shaped cross-section spar to a first composite panel of a torsion box of the aircraft comprises cocuring or cobounding, and joining the upper flanges of the double Y-shaped cross-section spar to a second composite panel of the torsion box of the aircraft comprises cocuring or cobounding.

Cobounding is a form of joining in which for example, the composites panels are previously cured and the flanges are uncured, and they are joined together using adhesive or vice-versa.

Cocuring implies that all the pieces e.g. upper and lower flanges and the first and second composite panels are cured at the same time, creating a bond between them without the need for adhesives.

A third aspect of the present invention refers to a torsion box that comprises a plurality of double Y-shaped cross-section spars connected to the first panel of the torsion box of the aircraft by the lower flanges and to the second panel of the torsion box of the aircraft by the upper flanges. The proposed double Y-shaped cross-section spars can be spaced in the torsion box further apart compared to conventional spars of the state of the art. Hence, the present invention permits to limit the number of spars of the invention providing a lighter torsion box.

In some examples the torsion box is a torsion box of a wing, a vertical tailplane torsion box or a horizontal tailplane torsion box.

A fourth aspect according to the present invention refers to a method for manufacturing a torsion box comprising the double Y-shaped cross-section spar according to the first aspect of the invention. The method comprises placing composite material onto first molds that comprise a molding curvature a between 100 to 165 degrees, wherein a is a working angle formed in a joint between the first cross-section opened triangular-shaped structure and the lower flanges or between the first cross-section opened triangular-shaped structure and the upper flanges, wherein the first molds are associated with at least the shape of the spar and the lower flanges and the upper flanges. The method further comprises placing second molds associated with the shape of the first cross-section opened triangular-shaped structure and the second cross-section opened triangular-shaped structure against the composite material, placing composite material at least onto the second molds, closing the first molds and the second molds with third molds to obtain a closed mold that contains a torsion box preform, wherein the third molds are associated with at least the shape of the first panel of the torsion box and the shape of the second panel of the torsion box of the aircraft, and curing the torsion box preform with an autoclave cycle.

In one example, the method further comprises cutting the torsion box preform to obtain the torsion box.

In one example, curing the torsion box preform with an autoclave cycle comprises curing the torsion box preform at 180 degrees Celsius or less.

In one example, curing the torsion box preform with an autoclave cycle comprises partial curing previous to a final curing.

In one example, the method further comprises placing rowings in between the first molds and second molds.

In one example, the method further comprises obtaining the first molds, the second molds and the third molds with 3D printing.

In one example, the method further comprises using carbon fiber with thermoset or thermoplastic resin or glass fiber with thermoset or thermoplastic resin as composite material.

In one example, a is equal to 135°.

### SUMMARY OF DRAWINGS

For a better understanding of the above explanation and for the sole purpose of providing an example, some non-limiting drawings are included that schematically depict a practical embodiment.

FIG. 1 shows a first example of the double Y-shaped cross-section spar according to the present invention.

FIG. 2 shows a second example of the double Y-shaped cross-section spar according to the present invention.

FIG. 3 shows other examples of the double Y-shaped cross-section spar according to the present invention.

FIG. 4 shows molds used in the manufacturing method of a torsion box comprising the double Y-shaped cross-section spar according to the present invention.

FIG. 5 shows an example torsion box comprising the double Y-shaped cross-section spar according to the present invention.

### DETAILED DESCRIPTION

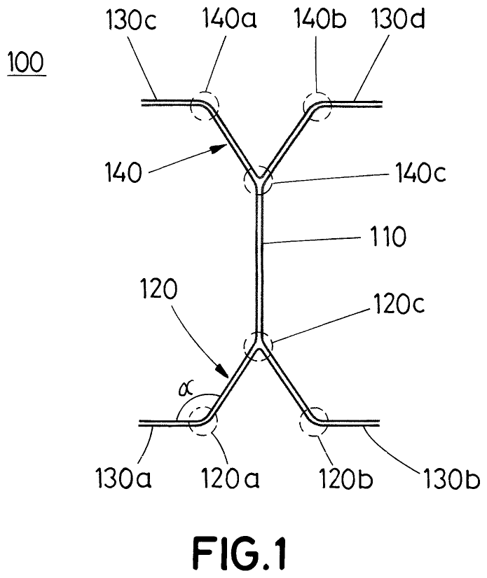

FIG. 1 shows a first example of the double Y-shaped cross-section spar (100) according to the present invention. The double Y-shaped cross-section spar (100) can be made of composite material. The double Y-shaped cross-section spar (100) extends along a longitudinal axis that may be in a spanwise direction of a torsion box.

The double Y-shaped cross-section spar (100) comprises a spar web (110) having a cross-section in an I-shape.

The double Y-shaped cross-section spar (100) comprises two parts connected by the spar web (110), i.e., a lower part, and an upper part.

The lower part comprises lower flanges (130a, 130b) that can be configured to be connectable to a first panel (1010) of the torsion box of the aircraft (as shown in FIG. 5), a first cross-section opened triangular-shaped structure (120) that comprises first and second lower vertices (120a, 120b) respectively joined to the lower flanges (130a, 130b) and an upper vertex (120c) connected to a first end of the spar web (110). The first cross-section opened triangular-shaped structure (120) includes arms each extending from the upper vertex (120c) to a respective one of the lower vertices (120a, 120b).

The upper part comprises upper flanges (130c, 130d) configured to be connectable to a second panel (1020) opposite the first panel (1010) of the torsion box of the aircraft, a second cross-section opened triangular-shaped structure (140) that comprises first and second upper vertices (140a, 140b) respectively joined to the upper flanges (130c, 130d) and a lower vertex (140c) connected to a second end of the spar web (110). The second cross-section opened triangular-shaped structure (140) includes arms each extending from the lower vertex (140c) to a respective one of the upper vertices (140a, 140b).

The first cross-section opened triangular-shaped structure (120), the second cross-section opened triangular-shaped structure (140) and the spar web (110) form a cross-section in a double Y-shape.

The double Y-shaped cross-section spar (100) the most suitable example according to the present invention for production as this would still have an optimal structural behavior and could easily be mass-produced with a fast prototyped mold using 3D printing techniques.

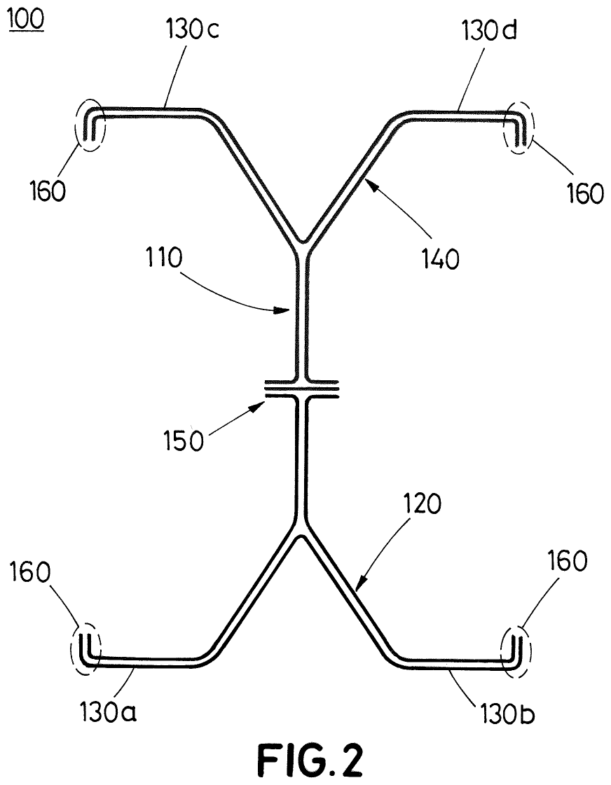

FIG. 2 shows a second example of the double Y-shaped cross-section spar (100) according to the present invention.

In this example, the double Y-shaped cross-section spar (100) comprises all the elements described in FIG. 1 and further incorporates vertical fins (160) connected to the lower flanges (130a, 130b) and to the upper flanges (130c, 130d). The vertical fins (160) are established in a parallel direction to the spar web (110).

Furthermore, the spar web (110) further comprises a cross-shaped cross-section that comprises an intermediate cap (150) that comprises upper and lower sections connected to each other, each section having a T-shape cross-section and comprising a symmetric laminate composed by:
a first layer comprising composite laminates that wrap the lower flanges, or upper flanges and the spar web, wherein a 70% of the total composite laminates from the first layer are oriented at a load angle +/−45°, wherein the load angle is the angle of the load with respect to the double Y-shaped spar reference axis;
a second layer comprising composite laminates that can be established on top of the first layer wherein a 70% of the total composite laminates from the first layer are oriented at a load angle 0°; and
a third layer comprising composite laminates that can be established on top of the second one, wherein a 70% of the total composite laminates from the third layer are oriented at a load angle +/−45°.

The example of double Y-shaped cross-section spar (100) comprises for the upper part and for the lower part flanges with vertical fins (160), and the web with a cross-shaped cross-section. This particular cross-section of the spar web (110) improves the behavior of the double Y-shaped cross-section spar (100) in the main load direction, enhancing the momentum of inertia and the elastic modulus (E) of the spar, but also stiffening the spar web (110) that decreases the probability of buckling.

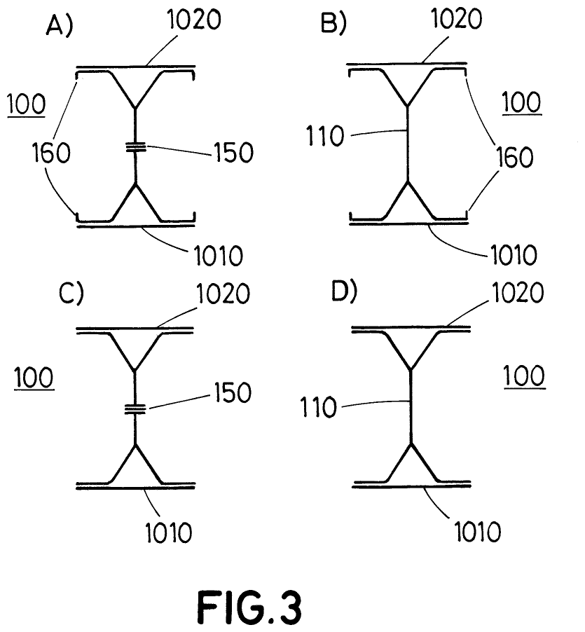

FIG. 3 shows four examples of the double Y-shaped cross-section spars (100) according to the present invention.

FIG. 3A shows the example described in previous FIG. 2.

FIG. 3B shows a double Y-shaped cross-section spar (100) that comprises a spar web (110) having a cross-section in a I-shape and wherein the lower flanges (130a, 130b) and the upper flanges (130c, 130d) comprise vertical fins (160) established in a parallel direction to the spar web (110).

FIG. 3C shows a double Y-shaped cross-section spar (100) that comprises a spar web (110) having a cross-shape cross-section.

FIG. 3D shows a double Y-shaped cross-section spar (100) comprising a spar web (110) having a cross-section in a I-shape.

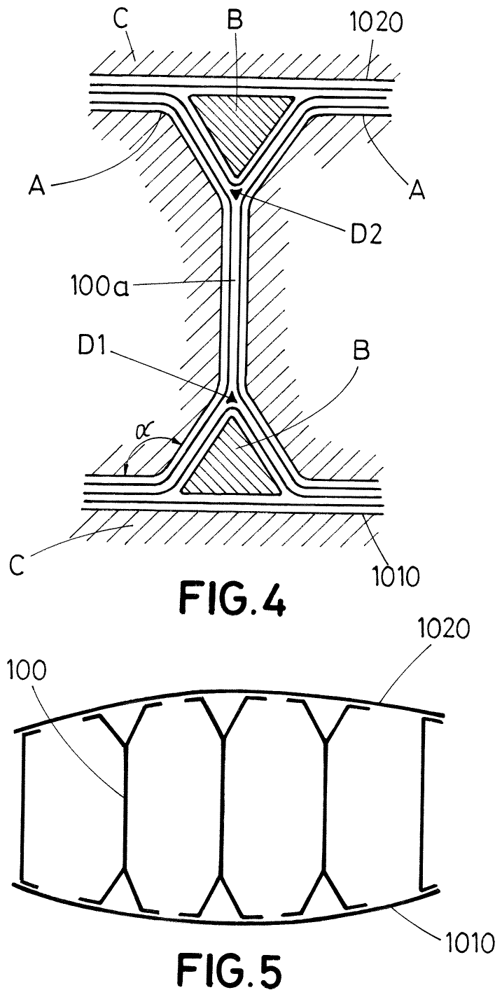

FIG. 4 shows molds used in the manufacturing method of a torsion box comprising the double Y-shaped cross-section spar according to the present invention.

The manufacturing double Y-shaped cross-section spar (100) can comprise placing composite material onto first molds (A) that comprise a molding curvature a between 100 to 165 degrees, wherein a is a working angle formed in a joint between the first cross-section opened triangular-shaped structure (120) and the lower flanges (130a, 130b) or between the first cross-section opened triangular-shaped structure (120) and the upper flanges (130c, 130d), wherein the first molds (A) are associated with at least the shape of the spar (110) and the lower flanges (130a, 130b) and the upper flanges (130c, 130d).

In one example, a is equal to 135°.

Placing the composite material can comprise a fiber placement process over the molds of pre impregnated fiber or dry fiber that can be later be infused with resin.

Furthermore, the manufacturing method comprises placing second molds (B) associated with the shape of the first cross-section opened triangular-shaped structure (120) and the second cross-section opened triangular-shaped structure (140) against the composite material.

Furthermore, the manufacturing method comprises placing composite material at least onto the second molds (B).

Furthermore, the manufacturing method comprises closing the first molds (A) and the second molds (B) with third molds (C) to obtain a closed mold that contains a torsion box preform (100a), wherein the third molds (C) are associated with at least the shape of the first panel (1010) of the torsion box and the shape of the second panel (1020) of the torsion box of the aircraft. Hence, the closing of the molding permits conforming the shape of the spar.

Furthermore, the manufacturing method comprises curing the torsion box preform (100a) with an autoclave cycle.

Furthermore, the manufacturing method comprises cutting the torsion box preform (100a) to obtain the double Y-shaped cross-section spar (100).

Furthermore, the manufacturing method comprises curing the torsion box preform (100a) with an autoclave cycle comprises curing the Y-shaped preform (100a) at 180 degrees Celsius or less.

Furthermore, the manufacturing method comprises placing rowings (D1, D2) in between the first molds (A) and second molds (B).

The method further comprises manufacturing the first molds (A), the second molds (B) and the third molds (C) with 3D printing.

The method further comprises using carbon fiber with thermoset or thermoplastic resin or glass fiber with thermoset or thermoplastic resin as composite material.

The first molds (A) and the second molds (B) conform the spar web (110), the second molds (B) and the third molds (C) conform the first cross-section opened triangular-shaped structure (120) and the second cross-section opened triangular-shaped structure (140) and the first panel (1010) of the torsion box and the second panel (1020) of the torsion box. The a is variable that can be adapted to optimize the load transmission, but those that ensure that no wrinkles are formed during the manufacturing.

FIG. 5 shows an example torsion box of a wing comprising the double Y-shaped cross-section spar according to the present invention. FIG. 5 shows a possible arrangement of a torsion box of a wing that shows the first panel (1010) of the torsion box and the second panel (1020) of the torsion box of the aircraft, a front and a rear spar and a plurality of double Y-shaped cross-section spar (100) that will vary depending on the dimensions of the torsion box.

The invention may be embodied as a double Y-shaped cross-section spar (100) for a torsion box of an aircraft, the double Y-shaped cross-section spar (100) comprising: a spar web (110) having a cross-section in a I-shape; a lower part and an upper part connected by the spar web (110), the lower part comprising: lower flanges (130a, 130b) configured to be connectable to a first panel (1010) of the torsion box of the aircraft; a first cross-section opened triangular-shaped structure (120) comprising: first and second lower vertices (120a, 120b) respectively joined to the lower flanges (130a, 130b); and an upper vertex (120c) connected to a first end of the spar web (110); and the upper part comprising: upper flanges (130c, 130d) configured to be connectable to a second panel (1020) opposite the first panel (1010) of the torsion box of the aircraft; a second cross-section opened triangular-shaped structure (140) comprising: first and second upper vertices (140a, 140b) respectively joined to the upper flanges (130c, 130d); and a lower vertex (140c) connected to a second end of the spar web (110), wherein the first cross-section opened triangular-shaped structure (120), the second cross-section opened triangular-shaped structure (140) and the spar web (110) form a cross-section in a double Y-shape.

The lower flanges (130a, 130b) and the upper flanges (130c, 130d) may be established in a perpendicular direction to the spar web (110).

The spar web (110) may further comprise an intermediate cap (150) having a cross-section in a cross-shape.

The intermediate cap (150) may comprise upper and lower sections connected to each other, each section having a T-shape cross-section each comprising a symmetric laminate composed by: a first layer comprising composite laminates that wrap the lower flanges (130a, 130b) or the upper flanges (130c, 130d) and the spar web (110), wherein a 70% of the total composite laminates from the first layer are oriented at a load angle +/−45°, wherein the load angle is the angle of the load with respect to the Y-shaped spar reference axis; a second layer comprising composite laminates that can be established on top of the first layer wherein a 70% of the total composite laminates from the first layer are oriented at a load angle 0°; and a third layer comprising composite laminates that can be established on top of the second one, wherein a 70% of the total composite laminates from the third layer are oriented at a load angle +/−45°.

The lower flanges (130a, 130b) and the upper flanges (130c, 130d) may comprise vertical fins (160) established in a parallel direction to the spar web (110).

The composite material may comprise carbon fiber with thermoset or thermoplastic resin or glass fiber with thermoset or thermoplastic resin.

The spar web (110) may further comprise manholes.

The double Y-shaped cross-section spar (100) may be used by joining the lower flanges (130a, 130b) of the double Y-shaped cross-section spar (100) to a first panel (1010) of a torsion box of the aircraft; and joining the upper flanges (130c, 130d) of the double Y-shaped cross-section spar (100) to a second panel (1020) of the torsion box of the aircraft, the second panel (1020) opposite to the first panel (1010).

The joining of the lower flanges (130a, 130b) of the double Y-shaped cross-section spar (100) to a first composite panel of a torsion box of the aircraft may comprise cocuring or cobounding, wherein joining the upper flanges (130c, 130d) of the double Y-shaped cross-section spar (100) to a second composite panel of the torsion box of the aircraft comprises cocuring or cobounding.

The invention may be embodied as a torsion box of an aircraft, the torsion box comprising: a first panel (1010); a second panel (1020); a plurality of the double Y-shaped cross-section spars (100), wherein the plurality of double Y-shaped cross-section spars (100) are connected to: the first panel (1010) by the lower flanges (130a, 130b); and the second panel (1020) by the upper flanges (130c, 130d).

The torsion box may be for a wing or a horizontal tailplane (HTP) or a vertical tailplane (VTP).

The invention may be embodied as a method for manufacturing a torsion box comprising the double Y-shaped cross-section spar (100) the method comprising: placing composite material onto first molds (A) that comprise a molding curvature a between 100 to 165 degrees, wherein a is a working angle formed in a joint between the first cross-section opened triangular-shaped structure (120) and the lower flanges (130a, 130b) or between the first cross-section opened triangular-shaped structure (120) and the upper flanges (130c, 130d), wherein the first molds (A) are associated with at least the shape of the spar (110) and the lower flanges (130a, 130b) and the upper flanges (130c, 130d); placing second molds (B) associated with the shape of the first cross-section opened triangular-shaped structure (120) and the second cross-section opened triangular-shaped structure (140) against the composite material; placing composite material at least onto the second molds (B); closing the first molds (A) and the second molds (B) with third molds (C) to obtain a closed mold that contains a torsion box preform (100a), wherein the third molds (C) are associated with at least the shape of the first panel (1010) of the torsion box and the shape of the second panel (1020) of the torsion box of the aircraft, and curing the torsion box preform (100a) with an autoclave cycle.

The method may include cutting the torsion box preform (100a) to obtain the double Y-shaped cross-section spar (100), and/or placing rowings (D1, D2) in between the first molds (A) and second molds (B).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A double Y-shaped cross-section spar configured for a torsion box of an aircraft, the double Y-shaped cross-section spar comprising:
a spar web having an I-shape in cross section;
a lower part connected to a lower edge of the spar web, wherein the lower part includes:
lower flanges configured to connect to a first panel of the torsion box,
a cross-section of the lower part having an opened triangular-shape, and the lower part including:
first and second vertices respectively joined to the lower flanges and
an upper vertex connected to the lower edge of the spar web;
an upper part connected to an upper edge of the spar web, wherein the upper part includes:
upper flanges configured to be connectable to a second panel opposite the first panel of the torsion box of the aircraft;
a cross-section of the lower part having an opened triangular-shaped structure, and
first and second upper vertices respectively joined to the upper flanges; and
a lower vertex connected to the upper edge of the spar web,
wherein an assembly of the lower part, the upper part and the spar web forms in cross section a double Y-shape.

2. The double Y-shaped cross-section spar according to claim 1, wherein the lower flanges and the upper flanges are perpendicular to an axis of the spar web, wherein the axis extends through the upper vertex and the lower vertex.

3. The double Y-shaped cross-section spar according to claim 1, wherein the spar web further comprises an intermediate cap having in cross-section a cross-shape.

4. The double Y-shaped cross-section spar according to claim 3, wherein the intermediate cap comprises an upper section and lower section connected to the upper section, and each of the upper and lower sections have in cross section a T-shape, and
each of the upper and lower sections comprise a symmetric laminate including:
a first layer comprising composite laminates that overlap the spar web and one of the lower flanges or one of the upper flanges, wherein 70% of the composite laminates in the first layer are oriented at a load angle of +/−45°, and the load angle is an angle of a load with respect to a Y-shaped spar reference axis;
a second layer comprising composite laminates on the first layer, wherein 70% of the composite laminates from the second layer are oriented at a load angle of 0°; and
a third layer comprising composite laminates on the second layer, wherein 70% of the composite laminates of the third layer are oriented at a load angle of +/−45°.

5. The double Y-shaped cross-section spar according to claim 1, further comprising vertical fins at respective distal edges of each of the lower flanges and the upper flanges, wherein the vertical fins are parallel to the spar web.

6. The double Y-shaped cross-section spar according to claim 1, wherein the composite material comprises carbon fiber with thermoset or thermoplastic resin or glass fiber with thermoset or thermoplastic resin.

7. The double Y-shaped cross-section spar according to claim 1, wherein the spar web further comprises manholes.

8. The double Y-shaped cross-section spar according to claim 1 wherein,
the lower flanges of the double Y-shaped cross-section spar are joined to a first panel of the torsion box of the aircraft; and
the upper flanges are joined to a second panel of the torsion box, wherein the second panel is opposite to the first panel.

9. The double Y-shaped spar according to claim 8, wherein the first and second composite panels are composite panels, and
the lower flanges are co-bounded or co-cured with the first panel, and
the upper flanges are co-bounded or co-cured with the second panel.

10. A torsion box of an aircraft, the torsion box comprising:
a first panel;
a second panel;
a plurality of the double Y-shaped cross-section spars according to claim 1, wherein the plurality of the double Y-shaped cross-section spars are connected to:
the first panel by the lower flanges; and
the second panel by the upper flanges.

11. The torsion box according to the claim 10, wherein the torsion box is in at least one of a wing, a horizontal tailplane (HTP) or a vertical tailplane (VTP).

12. A method for manufacturing a torsion box including a double Y-shaped cross-section spar of claim 10, the method comprising:
placing composite material onto first molds including a molding curvature a between 100 to 165 degrees, wherein a is a working angle formed in a joint between the first cross-section opened triangular-shaped structure and the lower flanges or between the first cross-section opened triangular-shaped structure and the upper flanges, wherein the first molds include surfaces shaped to conform to web spar, and the lower flanges and the upper flanges;
placing second molds including surfaces conforming to the first cross-section opened triangular-shaped structure and the second cross-section opened triangular-shaped structure against the composite material;
placing the composite material and onto the second molds;
closing the first molds and the second molds with third molds to obtain a closed mold that contains a torsion box preform, wherein the third molds include surfaces conforming to at least a shape of the first panel of the torsion box and a shape of the second panel, and
curing the torsion box preform with an autoclave cycle.

13. The method according to claim 12 further comprising cutting the torsion box preform to obtain the double Y-shaped cross-section spar.

14. The method according to claim 12, further comprising placing rowings between the first molds and the second molds.

15. The method according to claim 12, wherein a is equal to 135°.

16. A torsion box in an aircraft comprising:
a spar extending in a spanwise direction of the torsion box and having a double Y shape in cross-section, the spar comprising:
a spar web;
an upper first vertex at an upper edge of the spar web;
an upper pair of spar arms diverging as the upper pair of spar arms extend upwardly to respective upper second vertices;
upper spar flanges each connected to a respective one of the upper second vertices, wherein the upper spar flanges extend from the upper second vertices in opposing directions;
the lower first vertex at a lower edge of the spar web;
a lower pair of spar arms diverging as the lower pair of spar arms extend downwardly to respective lower second vertices;
lower spar flanges each connected to a respective one of the lower second vertices, wherein the lower spar flanges extend from the lower second vertices in opposing directions;
an upper panel including an inner surface connected to the upper spar flanges, and
a lower panel including an inner surface connected to the lower spar flanges.

17. The torsion box according to claim 16, wherein the lower flanges and the upper flanges are perpendicular to an axis of the spar web, wherein the axis extends through the upper vertex and the lower vertex.

18. The torsion box according to claim 17, wherein the spar web further comprises an intermediate cap having in cross-section a cross-shape.

19. The torsion box double according to claim 18, wherein the intermediate cap comprises:
an upper section and lower section connected to the upper section, and each of the upper section and the lower section forms in cross section a T-shape, and
each of the upper section and the lower section comprise a symmetric laminate including:
a first layer comprising composite laminates that overlap the spar web and one of the lower flanges or one of the upper flanges, wherein 70% of the composite laminates in the first layer are oriented at a load angle of +/−45°, and the load angle is an angle of a load with respect to a Y-shaped spar reference axis;
a second layer comprising composite laminates on the first layer, wherein 70% of the composite laminates from the second layer are oriented at a load angle of 0°; and
a third layer comprising composite laminates on the second layer, wherein 70% of the composite laminates of the third layer are oriented at a load angle of +/−45°.
